(19) United States
(12) Patent Application Publication
(10) Pub. No.: US 2011/0179044 A1
(43) Pub. Date: Jul. 21, 2011

(54) MORPHOLOGICAL ANALYSIS

(76) Inventors: William Richard Crum, Surrey (GB); Paul Ghazwan Aljabar, Berkshire (GB); Jan Paul Daniel Rueckert, London (GB)

(21) Appl. No.: 13/000,790

(22) PCT Filed: Jun. 23, 2009
(86) PCT No.: PCT/GB09/01571

§ 371 Date: Mar. 24, 2011

(30) Foreign Application Priority Data
Jun. 25, 2008 (GB) 0811671.7

(51) Int. Cl. G06F 17/30

(52) U.S. Cl. 707/749; 707/E17.014

(57) ABSTRACT

A method for deriving a biomarker from a structural analysis of medical images is described, including the calculation of pairwise, between-subject, measures of similarity and transformation of the pairwise measures of similarity into a subject specific biomarker. In one example, the biomarker is based on volume or shape comparisons of labelled and segmented anatomical structures in brain images from the subject and two or more clinical groups.

This invention relates to the analysis of morphological features in medical images to derive a biomarker representative of the absence or presence of a condition, for example such as Alzheimer's disease in brain images.

Magnetic resonance imaging (MRI) of the brain has become an indispensable tool for diagnosis and research in neuroimaging. Segmentation of brain regions of structural or functional interest is a requirement for quantitative studies of morphology as it provides a neuroanatomical context to subsequent measurements or forms the basis of those measurements. The classic structural neuroimaging experiment seeks morphological measures which discriminate two sets of subjects grouped on the basis of other information (such as genetics, neuro-psychology, medication, etc). A related experiment first discovers such discriminators from training data and then applies them to classify new subjects. This can form the basis of a diagnostic system e.g. (see for example Kloppel et al. 2008, Brain 131(3), 681). Techniques employed range from simple manual volumetry (Jack Jr et al. 1997, Neurology 49, 786) to sophisticated shape-based measurement and classification techniques (Wang et al. 2007, IEEE Transaction and Medical Imaging 26(4), 462). The alternative framework of “hypothesis-free” analysis exemplified by Voxel Based Morphometry (VBM) (Ashburner and Friston 2000, Neuroimage 11(6), 805) is concerned with the detection and significance of local tissue density differences rather than an analysis of their morphological structure. More recent developments such as the incorporation of local measures of volume change into VBM as well as so-called Deformation-Based-Morphometry (Ashburner et al. 1998 Human Brain Mapping 6, 638) and Tensor-Based-Morphometry (Studholme et al. 2004, Neuroimage 21(4), 1387) have blurred the operational distinction between traditional morphological analysis and voxel-wise methods. While there is on-going debate about the reliability and interpretation of hypothesis-free techniques (Bookstein, 2001 Neuroimage 14(6), 1452; Davatzikos, 2004, Neuroimage 23, 17), morphological analysis of individual structures, identified either manually or with computer-assistance, is an established practice.

Manual segmentation methods requiring expert neuroanatomical knowledge or at least a protocol derived from expert knowledge, have been used for many years, and retain particular importance in the case of structures which challenge automatic segmentation techniques such as the hippocampus (Jack Jr et al, 1997; Pruessner et al. 2000, Cerebral Cortex 10(4), 433) and the entorhinal cortex (Du et al. 2001, Journal of Neurology, Neuroimaging and Psychiatry 71(4), 441). Such methods are time-consuming and suffer from errors which are a function of a range of human factors (e.g. inter- and intra-observer variation, practice and temporal drift effects), segmentation protocol details and acquisition details (scan signal and contrast characteristics, patient motion and other artifacts, other scanner calibration and performance issues etc). In parallel there has been a huge amount of research effort devoted to automation, from techniques which simply separate brain from non-brain (Smith, 2002, Human Brain Mapping 17(3), 143) to those which provide detailed gyral and sulcal labelling (Mangin et al. 2004, IEEE Transactions on Medical Imaging 23(8), 968). Automated techniques have improved immensely but can be computationally demanding, complex, and sensitive to image acquisition details and the presence of abnormal anatomy (Duncan and Ayache 2000, IEEE Transactions on Pattern Analysis and Machine Intelligence 22(1), 85). Nevertheless, the identification of brain structures and/or tissue-classes is a necessary prerequisite to virtually all morphological analyses. The simplest and most common analysis which depends on neuroanatomical labeling is a cross-sectional (single time-point) volumetric comparison. Many authors have investigated higher-order measures of shape (Csernansky et al. 1998 Proceedings of the National Academy of Sciences 95(19), 11406; Kim et al. 2005 Lecture Notes in Computer Science, Vol 3581, 353; Wang et al. 2006, Neurolmage 30(1), 52) with varied success and interpretation of results and reproducibility on large cohorts remains difficult.

In one aspect of the invention, there is provided a method of deriving a biomarker indicative of the presence or absence (or progression) of a condition, such as a medical condition or illness, in a query subject, as defined in claim 1. In further aspects of the invention, a computer program as defined in claim 22 and a computer system as defined in claim 24 are provided.

In some embodiments, the method comprises defining a set of pairwise measures of similarity between anatomical structures in a set of images which includes a group of control subjects in which the condition is absent, a group of condition subjects in which the condition is present (or groups of subjects at respective different stages of the condition) and the query subject. More than one query subject may be analysed simultaneously in this way by adding images from further query subjects to the set to be analysed. The biomarker is then derived by transforming the pairwise measures into an indicator variable (or set of variables such as a vector). The set of pairwise measures may be defined by calculating a measure of similarity between one or more structures in the query image and images from the remaining subjects in the set of images and retrieving pre-calculated measures between the structures in images from the remaining subjects. In this fashion, the amount of calculation for each query subject is reduced.

The measure of similarity may be derived from a difference in the volume of one or more respective anatomical structures in the images. Alternatively (or additionally) the measure of similarity may be calculated as a measure of the overlap between one or more respective anatomical structures. Advantageously, such an overlap measure retains at least some of the morphological information of the structures and can therefore be seen as a more informative measure than a scalar comparison of volume alone. Where the measure is derived from a plurality of structures, a component biomaker may be derived for each structure individually and then combined to form the biomaker or a compound measure of similarity may be calculated for the structures, for example a generalised Dice overlap measure (Crum et al. 2006, IEEE Transactions on Medical Imaging 25(11), 1451), which is then transformed into the biomarker as for a single measure of similarity from a single structure.

In some embodiments, the pairwise similarity measures are transformed to define the biomarker by performing a spectral analysis of a graph with nodes representing subjects (images) and weighted edges between the nodes representing the measure of similarity. This involves calculating a graph Laplacian and deriving the biomarker using one or more of the eigenvectors of the Laplacian with non-zero eigenvalue. For example, the biomarker (or one of its components) may be defined as the component corresponding to the query subject of the eigenvector having the largest eigenvalue, the so-called Fiedler vector. Alternatively, in some embodiments the biomarker is defined as a set of values derived from the components corresponding to the query subject of a number of eigenvectors having the largest respective eigenvalues.

In some embodiments, when the biomarker is constructed from a plurality of structures, these may be preselected as those structures for which the respective components of the biomarker individually provide the largest separation between control and condition subjects. They may also be preselected based on prior knowledge of any links with the condition.

In one exemplar application, the medical images may be brain images, (for example, magnetic resonance imaging (MRI) or computer assisted tomography (CT). More particularly, an exemplar condition which may be studied or tested using the techniques described herein is Alzheimer's disease. In this particular case, some embodiments use the following structures to distinguish between control and condition subjects: left and right hippocampus, left and right thalamus and the right lateral ventricle.

In some embodiments, the biomarker is used as an input to a classifer to classify the query subject as having the condition or not having the condition. The classifier may be a supervised classifier such as a Fisher Linear Discriminant or an unsupervised classifier such as k-means or fuzzy c-means classifier may be used. In the latter case, the output of the classifier may be a real value score indicative of which class the query subject belongs to.

In addition to providing a classification at a single point in time, the biomarker described above is used in some embodiments to map disease progression by calculating a biomarker or classification score on images obtained at a first point in time and a further biomarker or classification score on images obtained at a second point in time and detecting a change between the biomarker or classification scores at the first and second points in time.

The biomarker may be used to assess whether a subject should be entered into a study or the biomarker may be used as contextual data to refine the analysis of other data in a study.

Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or input and display devices.

For the avoidance of doubt, it is understood that references to a computer or a computer platform or apparatus are not intended to be limited to a single physical entity or piece of equipment but equally include a distributed computer system, for example of networked components.

Embodiments of the invention are now described by way of example only and with reference to the accompanying drawings in which:

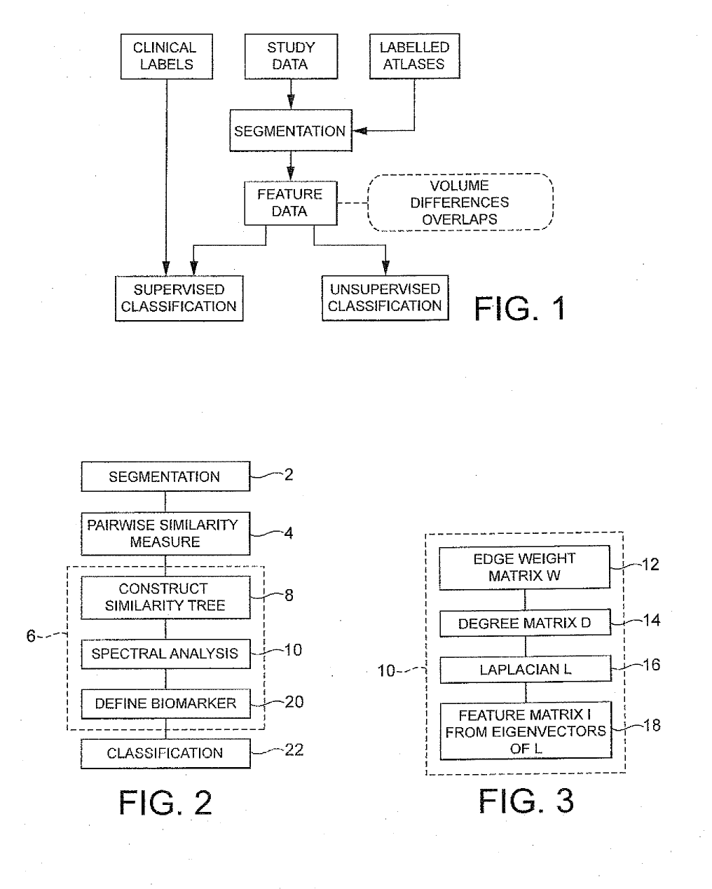

FIG. 1 shows a schematic overview of an analysis pipeline for deriving a biomarker;

FIG. 2 shows a flow diagram of a method of deriving a biomarker and using it for classification; and

FIG. 3 shows a more detailed flow diagram of a spectral analysis step in the flow diagram of FIG. 2.

In overview, high quality structural segmentation using state-of-the-art automated label-fusion based segmentation techniques (Heckemann et al., Neurolmage 33(1), 115; Aljabar et al. 2007 MICCAI '07, Vol 4791 of Lecture Notes in Computer Science, pp 523-531, herewith incorporated by reference herein) are used for image segmentation in a first step. These techniques segment brain images into labelled structures by selecting candidate segmentation atlases from a pre-existing database. By appropriate combination of candidate labels at the voxel level, these techniques become robust to many sources of random error including unavoidable anatomical variation, registration error and random labelling errors in the atlas population. The following analysis steps derive a biomarker indicative of the presence, absence or degree of a condition from pairwise comparisions between a query image, a plurality of control images and a plurality of images from subjects with the condition. Group morphology is summarized by constructing a fully connected graph where each subject is represented by a node and pairs of nodes are connected with edge-weights that are a function of the morphological similarity (e.g. label overlap, that is morphological overlap between corresponding structures in a pair of subjects having the same label from segmentation) of one or more structures. Spectral analysis techniques (von Luxburg, 2007 Statistics and Computing 17(4), 395, herewith incorporated by reference herein) are applied to the graph to generate indicator vectors which can be used to partition the graph, and therefore the subjects, on the basis of morphological similarity. A schematic of the analysis framework is shown in FIG. 1.

Before anatomical structures can be compared to derive pairwise similarity measures, an initial segmentation step 2 is required to segment the images into anatomical structures and label the resulting segmented structures so that corresponding structures can be compared between images. Image segmentation is now described in brief detail, employing techniques known in the art.

If an accurate manual segmentation is available for an anatomical image, it can be treated as an atlas and the approach described as atlas-based segmentation (Iosifescu et al. 1997, Neuroimage 6(1), 13, herewith incorporated by reference herein; Svarer et al. 2005, Neuroimage 24(4), 969, herewith incorporated by reference herein) can be used to generate a segmentation of a query (new) image. The atlas image is first non-rigidly registered to the query image to obtain a correspondence estimate. This allows the atlas structural labelling to be propagated to the query image, providing a segmentation estimate of the query image.

To overcome potential errors in the propagation of a single atlas labelling, labels from multiple atlases can be propagated to the query image and fused to form a single segmentation estimate. Simple fusion using a per-voxel vote rule, (where the majority label is assigned to the voxel) has previously performed well compared with other atlas based methods (Rohlfing et al. 2004, Neuroimage 21(4), 1428 herewith incorporated by reference herein). In particular, the vote rule has been shown to perform better than other classifier fusion rules in a general pattern recognition context (Kittler et al. 1998, IEEE Transactions of Pattern Analysis and Machine Intelligence 20(3), 226, herewith incorporated by reference herein). When applied to the segmentation of MR images of the human brain, classifier fusion has been shown to be robust and accurate, achieving levels of accuracy comparable with expert manual raters (Heckemann et al. 2006 Neuroimage 33(1), 115, herewith incorporated by reference herein). If the number of atlases available for a classifier fusion scheme is very large, other factors become important. As well as representing a significant computational burden, the propagation and fusion of labels from all the atlases in a large repository is less likely to represent the individual query subject and more likely to represent the population mean. This motivates the use of a scheme for selecting the most appropriate classifiers for the query, prior to propagation and fusion.

In the segmentation step 2, the method proposed by (Aljabar et al. 2007) is adopted as follows:

Classifier Selection
Affinely register the atlas images and the query image to a common reference space.
Rank the atlas images based on their similarity with query.
Choose the n top-ranked atlases as classifiers.

Segmentation
Non-rigidly register the selected classifiers with the query image.
Propagate classifier labels to query and fuse using the vote rule.

In some embodiments, the reference space used is defined by the MNI single subject atlas (Cocosco et al. 1997, Neuroimage 5(4), herewith incorporated by reference herein). Normalised mutual information (Studholme et al. 1999 Pattern Recognition 32(1), 71 herewith incorporated by reference herein) is used to assess the similarity of atlases with the query over a region of interest encompassing the subcortical structures studied and the top 20 classifiers are selected for the segmentation step. Finally, information derived from an expectation maximisation (EM) based tissue segmentation (Leemput et al. 1999 IEEE Transactions on Medical Imaging 18(10), 897, herewith incorporated by reference herein, Murgasova et al. 2006 MICCAI '06, Vol 4190 of Lecture Notes in Computer Science pp 687-694, herewith incorporated by reference herein) is used in a correction step for the label fusion segmentations. Specifically, the EM algorithm was used to generate tissue probability maps for grey and white matter and for cerebro-spinal fluid (CSF). Regions marked as tissue by label fusion that are assigned a high probability (>0.75) of CSF by the EM approach are identified and re-labeled as CSF. This reduces the errors associated with the tendency of segmentation to underestimate internal CSF spaces for subjects with large ventricles and increased parahippocampal CSF. This is particularly important for applications in dementia.

An automated morphological analysis of groups uses measures which quantify the morphological similarity of corresponding structures in the segmented images between pairs of subjects in some embodiments. Pairwise low-order morphological similarity measures are derived from measures of overlap of corresponding structures at step 4 in some embodiments. In some embodiments measures based on volumetric differences of corresponding labeled are used.

In some embodiments, overlap measures, which are typically used to compare the agreement between segmentations, e.g. between manual and automatic segmentation, are used as the pairwise similarly measure. In particular, the Dice overlap coefficient is used to measure overlaps. It is defined as the ratio of volume intersection to mean volume for a pair of binary labels. If N (A), N (B) and N (A∩B) represent the volumes of two labels and their intersection, then the Dice coefficient is defined as:

$$d = \frac{2 N ( A ⋂ B )}{N ( A ) + N ( B )}$$

Simple Dice overlaps compare a single pair of labelled segmented structures. When comparing two brains, the overlaps between several different labeled structures may be a more sensitive indicator than comparing each individual structure in turn.

Generalised overlap measures which summarise the agreements of multiple labels in terms of the total intersection and total mean volume were defined by (Crum et al. 2006, IEEE Transactions on Medical Imaging 25(11), 1451, herewith incorporated by reference herein). The generalised Dice coefficient is given by

$$d = \frac{2 {\sum }_{i} {α}_{i} N ( {A}_{i} ⋂ {B}_{i} )}{{\sum }_{i} {α}_{i} ( N ( {A}_{i} ) + N ( {B}_{i} ) )}$$

and is used as compound measure of similarly in some embodiments where the weights, αᵢ, control the relative impact of small versus large labels. Choosing αᵢ as the inverse square of the average volumes of Aᵢ and Bᵢ (Crum et al. 2006) makes the label pair contribute to the overall overlap in inverse proportion to its volume. Simple and generalised overlaps both represent pairwise measures of similarity between subjects and can therefore both be used in the comparison step 4.

In some embodiments, a normalised similarity measure between subjects calculated from the difference in volume of corresponding structures is used in the pairwise comparison step 4. Volume differences represent a measure of pairwise discrepancy between subjects and, as for the Dice coefficient, need to be converted to a measure of similarity before use in a spectral analysis step. If the volumes of a particular structure for N subjects after affine alignment are s₁, . . . , s_{N}, then s′₁, . . . , s′_{N} are the same volumes transformed to z-scores by subtracting the mean and dividing by the standard deviation calculated. The reason for using z-scores rather than raw volumes is that the same parametric similarity measure can be used for different structures. A normalised measure of volumetric similarity between subjects i and j is then

$${v}_{ij} = \frac{1}{c} exp ( - \frac{{( {s}_{i}^{′} - {s}_{j}^{′} )}^{2}}{{c}^{2}} )$$

where c=2 parametrises the kernel width.

In some embodiments, a structural measure other than volume is used, or any summative measure derived from the structured segmentation. Similarity functions other than a Gaussian are used in some embodiments.

The similarity measures described above all describe a pairwise similarity between two respective images (respective subjects) at a time. To derive a biomarker indicative of whether a given query subject has a condition under study or not, it is necessary to convert these pairwise measures into a single measure for the query subject. The pairwise similarities are transformed into a biomarker for the query subject at step 6, as described below in detail.

The technique of spectral analysis is used to convert the similarity measures described above from a measure of similarity between pairs of subjects to per-subject feature data for use in classification. At step 8 the pairwise measures of morphological similarity are used to, in effect, construct a complete, undirected, weighted graph which summarises the morphological similarity, described above, between all pair-wise combinations of N subjects. In the graph representation, each node represents a subject and the edge weight connecting two nodes represents one of the measures of similarity discussed above between the corresponding subjects. At step 10, spectral analysis techniques are applied to the graph to generate indicator values or vectors which summarise the group similarity structure and can be used to partition the cohort into two sub-groups on the basis of morphology. The essential motivation for this class of techniques is that they make use of similarity relationships between all pairs of data points in order to associate the abstract data points with feature vectors in R^{k}, where the dimension of the feature vectors, k, can be chosen

With reference to FIG. 3, a brief description of the practical implementation steps of a specific normalised spectral analysis approach adopted in one embodiment follows; see (Ng et al. 2002, Advances in Neural Information Processing Systems 14, 849, herewith incorporated by reference herein) for more detail. For N subjects, a N×N matrix W of edge weights is defined at step 12 from the graph described above, where W=(wᵢⱼ), i,j=1, . . . , N and wᵢⱼ represents the similarity of subjects i and j. The diagonal degree matrix D, which measures the total similarity between each subject and all others, is constructed from W at step 14 by summing the edge-weights along each row, Dᵢᵢ=Σⱼ₌₁^{N}wᵢⱼ. At step 16, D and W are used to construct the normalised Laplacian L (Fan, 1997, Spectral Graph Theory, American Mathematical Society, herewith incorporated by reference herein), where L=D^{-1/2}(D−W)D^{-1/2}, which contains the information required to cluster the subjects. L is symmetric positive semi-definite and therefore has real non-negative eigenvalues. From the definition of D, it can be shown that the vector D^{-1/2}1 is an eigenvector of L with eigenvalue zero. It can also be shown that the remaining eigenvalues are all positive (Fan, 1997) and therefore provide an ordering for the corresponding eigenvectors. Let v₂, . . . , vₖ represent an ordered selection of eigenvectors starting with the eigenvector corresponding to the first non-zero eigenvalue (i.e. the second eigenvalue). A feature matrix F is constructed at step 18 by taking v₂, . . . , vₖ as columns and normalising its rows to one. The rows of this matrix correspond to the original subjects and can be used as feature vectors in a clustering algorithm. The features become scalar cluster indicator variables if only the first of these eigenvectors—the ‘Fiedler vector’ (Fan, 1997)—is used.

A biomarker for the query subject is derived from the feature matrix F at step 20. In one embodiment, the component of the Fiedler vector corresponding to the query subject (for example the first component if the query subject has been indexed with index 1 in the weight matrix described above) is extracted as the biomarker. In some embodiments, where more than one segmented structure is compared between subjects, the algorithm for calculating a biomarker described above is iterated for each such structure to derive a component biomarker from each structure comparison and forming the biomarker as a vector with the component biomarkers as components.

In an alternative approach, a combined pairwise measure of similarity is derived for the plurality of structures, for example the generalised Dice coefficient described above to define a single similarity graph to which spectral analysis is applied. Multi-dimensional features can be obtained by using the components of eigenvectors other than the Fiedler vector may be included in the biomarker to define a vector biomarker having a plurality of component values corresponding to the relevant component of each eigenvector. Although this is particularly applicable where a combined similarity measure is used to construct the graph, a vector biomarker can equally be defined for graphs based on other similarity measure. For example, the first N eigenvectors having the largest eigenvalues are used in some embodiments and, more particularly, the first 8 eigenvectors are used in some embodiments.

The derivation of a biomarker for a query subject (query image) as described above requires a pairwise comparison between the query image and predefined sets of images from control subjects which are known not to have the condition and condition subjects which are known to have the condition. Steps 2 and 4 described above, in particular, require computational steps to segment the images at step 2 and calculate pairwise similarity measures at step 4. Accordingly, in some embodiments, these steps are only repeated for a new query image when a biomarker for a new query image is to be computed. The segmented images of the condition and control subjects are stored in memory, along with their pre-calculated pairwise similarity measures. Thus, if a biomarker for a new query image is to be calculated, only the query image needs to be segmented at step 2 and, at step 4 and only the pairwise similarity measures between the query image and each of the condition and control images needs to be calculated, rather than recalculating the whole set of data.

Once a biomarker is derived as described above, it can be used as an input to a classification algorithm to classify the query subject at step 22 as either belonging to the control group (without the condition) or the condition group (with the condition present). The output may either be a binary indicator variable in some embodiments or a real number indicating class belonging in others. The classification algorithm is trained on the control and condition subjects using supervised methods or applied directly using unsupervised methods.

An example of a surpervised algorithm which is applied in some embodiments is Fisher Linear Discriminant Analysis (Fisher 1936, Annals of Eugenics 7(II), 179, herewith incorporated by reference herein). This method determines a classification rule which estimates the best direction within the data that predicts the clinical labels of the training subjects. Being a surpervised algorithm, this analysis requires clinical labels to be known but these are of course readily available in the case of the control subject (condition not present) and the condition subject (condition present).

Alternatively, an unsupervised classifier is trained on the entire data set including the query subject. For example, the well-known k-means clustering (Macqueen 1967, Proceedings of the Fifth Berkeley Symposium on Mathematical Statistics and Probability, University of California Press, pp 281, incorporated herein by reference herewith). In k-means clustering, an iterative procedure assigns each data-point to the nearest of a number of data clusters and the clusters centres are updated at each iteration as the centroid of their associated data points. An extension of this method, fuzzy c-means is used instead of the k-means algorithm in some embodiments (Dunn 1973, Journal of Cybernetics 3, 32; Bezdek 1981 Pattern Recognition with Fuzzy Objective Function Algorithms, Plenum Press; both incorporated herewith by reference herein). In fuzzy c-means, each data point is allowed to have partial membership of all clusters and the cluster centres are updated using a sum of all data points weighted by the strength of their membership to each cluster. In alternative embodiments, the cluster centres of the c-means or k-means algorithm, as applicable are pre-calculated using the condition and control subject images only to form a fixed classifier and the query subject can then be classified by comparing the query subjects biomarker to the clusters centres derived in this way, for example using a proximity measure.

Applications of the methods described above include the analysis of brain images, for example to detect the onset of Alzheimer's disease. A set of particular experimental results resulting from the application of the methods described above are now presented.

As described above, pre-labelled images are required to form an atlas pool for segmentation and label fusion. 275 anonymised MRI images from subjects were used for this purpose, a subset of which is publicly available as part of the internet brain segmentation repository (http://www.cma.mgh.harvard.edu/ibsr). This database was constructed from cohorts used in previous clinical research studies and includes male and female subject of varying ages, left and right handed and with varying numbers designated “normal”, “Alzheimer”, “schizophrenic”, “cocaine-user”, “ADHD”, and “psychotic”. Each image in the database had subcortical manual labels of the following structures: lateral ventricle, thalamus, caudate, putamen, pallidium, hippocampus, amygdala, accumbens, brainstem.

The study group comprised 38 subjects diagnosed with probable Alzheimer's disease and 19 age-matched controls. The subjects were selected according to the criteria of being older than 55 years and having a mini-mental state exam score of more than 27 for controls or in the range of 13-26 inclusive for probable Alzheimer's disease. The gender match was 23/38 (Alzheimer's) and 10/19 (controls) women. The group ages were: Alzheimer's disease 69.8±7 years and controls 69.3±7 years. The Alzheimer's disease and control mini-mental state exam scores were 19.5±4.0 and 29.5±0.7, respectively. More details about these cohorts can be found in Schott 2005, Neurology 65(1), 119, herewith incorporated by reference herein. Since the study group demographic is not typical of the atlas pool, controlled experiments were carried out to ensure that label fusion is not biased for or against this group. No such bias was detected in the atlas pool of 275 subjects, although 248 of the subjects were aged below 60 years with only 27 subjects being aged 60 years or above. No bias in the label fusion process was detected using the Dice overlap of the automatically obtained structural labels with each subject's pre-existing manual label.

Three sets of experiments were carried out, using feature data from spectral analysis of similarities derived from volume differences, feature data from spectral analysis of Dice overlaps and the volumes of the label structures after affine alignment of the subjects for comparisons. Additionally, experiments were carried out using comparisons between 17 structures or between a selection of the five best discriminating structures (as measured by T statistics). Finally, results were obtained for a particular embodiment where pairwise comparisons between five selected structures were made using the generalised Dice overlap measure described above and classification was performed either on the Fiedler component of the query subject or the relevant eigenvector components from the eight largest eigenvectors, as described in more detail above. For all classification experiments, the “query subject” was simulated using leave-one-out validation to calculate classification rates. The results are set out in the tables below.

TABLE 1
The top performing structures and corresponding absolute t-
statistics based on t-tests for group separation.

| | | Volume | | | |
|---|---|---|---|---|---|
| Volumes | | Differences | | Volume Overlaps | |
| Label | abs(t) | Label | abs(t) | Label | abs(t) |
| L-Thal | 4.134 | L-Hipp | 3.5481 | L-Hipp | 5.2654 |
| R-Hipp | 3.6266 | L-Thal | 3.0711 | R-Hipp | 4.7182 |
| R-Thal | 3.4348 | R-Hipp | 2.8582 | R-LV | 4.1102 |
| L-Hipp | 3.3174 | R-Acc | 2.6637 | L-Thal | 3.5481 |
| R-Pal | 3.1999 | L-LV | 2.3235 | R-Thal | 3.3398 |
| R-Amyg | 2.8534 | R-Amyg | 1.7948 | R-Amyg | 3.3398 |
| L-Acc | 2.7667 | R-Pal | 1.7948 | L-LV | 2.4469 |

The data sources were the volumes of labels or Fiedler vectors derived from volume differences or overlaps.
Prefixes indicate left (L) and right (R).
Abbreviations are:
Hipp: hippocampus;
LV: lateral ventricle;
Thal: thalamus;
Amyg: amygdala;
Acc: accumbens;
Pal: pallidum.

TABLE 2
T-statistics based on Fiedler vector components derived from
aggregated overlap Laplacian matrices. Either all labels (k = 17) were
aggregated or the selection that best separated the group on an individual
basis were used (left hippocampus, right hippocampus, right lateral
ventricle, left thalamus, right thalamus). See Table 1 final column.

| Structures | T-statistic | p-value |
|---|---|---|
| All | 2.8998 | 0.0053 |
| Selection | 7.2256 | <0.0001 |

TABLE 3
Sensitivity, specificity and classification rate when using feature
vectors representing volumes (V) or Fiedler vector components derived
from volume differences (D) or from overlaps (O). Experiments are
ordered according to whether the classifier used was supervised FLD
(sup) or unsupervised c-means (unsup) and whether all (k = 17, all)
or a selection (k = 5 sel) of structures were used.

| Combi- | Specificity | | | Sensitivity | | | Rate | | |
|---|---|---|---|---|---|---|---|---|---|
| nation | V | D | O | V | D | O | V | D | O |
| sup-all | 0.74 | 0.58 | 0.89 | 0.72 | 0.69 | 0.77 | 0.72 | 0.66 | 0.81 |
| sup-sel | 0.79 | 0.74 | 0.89 | 0.74 | 0.74 | 0.82 | 0.76 | 0.74 | 0.84 |
| unsup- | 0.79 | 0.68 | 0.84 | 0.79 | 0.82 | 0.74 | 0.79 | 0.78 | 0.78 |
| all | | | | | | | | | |
| unsup- | 0.79 | 0.79 | 0.89 | 0.77 | 0.85 | 0.82 | 0.78 | 0.83 | 0.84 |
| sel | | | | | | | | | |

TABLE 4
The classification performance based on the Fiedler
component taken from a single aggregated overlap (using generalised Dice
measure) Laplacian is compared with the performance of vectors derived
from separate Laplacians for the top five structures with respect to group
separation. The Figures. in the top two rows of the table are taken from the
overlaps (O) sup-sel and unsup-sel cases in Table 3.

| Data | Classifier | Specificity | Sensitivity | Rate |
|---|---|---|---|---|
| Separate | Supervised | 0.89 | 0.82 | 0.84 |
| structure | | | | |
| overlaps | | | | |
| | Unsupervised | 0.89 | 0.82 | 0.84 |
| Aggregated | Supervised | 0.89 | 0.69 | 0.76 |
| overlaps | | | | |
| | Unsupervised | 0.89 | 0.69 | 0.76 |

TABLE 5
The classification performance based on the use of 8
eigenvectors components taken from a single Laplacian derived from the
aggregated overlaps. These overlaps were obtained using the top 5
structures with respect to group separation (see Table 1).

| Classifier | Sens | Spec | Rate |
|---|---|---|---|
| Supervised | 0.89 | 0.84 | 0.86 |
| Unsupervised | 0.89 | 0.92 | 0.92 |

The above description of embodiments of the invention is made by way of example only and numerous modifications and alterations will be apparent to the person skilled in the art. For example, two dimensional medical images rather than three dimensional brain images, as described above, can be used in the analysis of an anatomical structure, in which case the references to “volumes” will be understood to refer to “areas”. Equally, other classifiers, as are well known in the art, can be used to classify subjects based on the biomarker described above or the biomarkers may be used in alternative algorithms for analysing the subject data.

The method is not limited to deriving a biomarker which distinguishes between controls and subjects having a condition. For example, a distinction may be made between more than two groups (control/condition), for example three groups (control, early stage of condition, late stage of condition) by using images from the relevant groups. More generally, a distinction may be made between a plurality of groups at respective condition states or stages of progression of the condition. The resulting graph can then be analysed as described above with classification algorithms adapted accordingly, for example using k or c means with the number of clusters corresponding to the number of groups.

Some embodiments may be in hardware, such as implemented to operate on a device or combination of devices, for example, whereas some embodiments may be in software. Likewise, embodiments may be implemented in firmware, or as any combination of hardware, software, and/or firmware, for example. Likewise, although claimed subject matter is not limited in scope in this respect, embodiments may comprise one or more articles, such as a carrier or storage medium or storage media. The storage media, such as, one or more CD-ROMs solid state memory, magneto-optical disk and/or magnetic disks or tapes, for example, may have stored thereon instructions, that when executed by a system, such as a computer system, computing platform, or other system, for example, may result in embodiments of a method in accordance with claimed subject matter being executed, such as one of the embodiments previously described, for example. Embodiments may comprise a carrier signal on a telecommunications medium, for example a telecommunications network. Examples of suitable carrier signals include a radio frequency signal, an optical signal, and/or an electronic signal.

While certain features have been illustrated and/or described herein for the purpose of explanation, many modifications, substitutions, changes and/or equivalents will now occur to those skilled in the art. It is, therefore, to be understood that the appended claims are intended to cover all such modifications and/or changes as fall within the scope of claimed subject matter.

1. A method of deriving a biomarker indicative of the presence or absence of a condition in a query subject including:
defining a set of respective digital medical images from the query subject, a group of control subjects in which the condition is absent and a group of condition subjects in which the condition is present, the images being segmented into one or more labelled anatomical structures;
defining a set of pairwise measures of similarity by comparing one or more respective anatomical structures for each pair of images in the set of images; and
deriving the biomarker from the pairwise measures of similarity.

2. A method as claimed in claim 1 which includes calculating pairwise measures of similarity between the query subject and the remaining subjects and retrieving pre-calculated pairwise measures between the remaining subjects from a memory to define the set of pairwise measures.

3. A method as claimed in claim 1 in which the pairwise measure is a measure of overlap between the one or more anatomical structures.

4. A method as claimed in claim 3 in which a plurality of respective anatomical structures is compared between the subjects to calculate a compound measure of overlap between respective structures as the pairwise measure.

5. A method as claimed in claim 1 in which the pairwise measure is a function of the difference in volume of the one or more anatomical structures.

6. A method as claimed in claim 1 in which the pairwise measure is a function of the difference in a summative measure of the one or more anatomical structures.

7. A method as claimed in claim 3 in which a plurality of structures are compared to derive one measure per structure, the measures each being transformed into a corresponding component of the biomarker.

8. A method as claimed in claim 1 which further includes defining a graph structure with nodes representing images and weighted edges representing the measure of similarity between nodes; calculating a graph Laplacian and deriving a biomarker from one or more eigenvectors of the Laplacian which have non-zero eigen values.

9. A method as claimed in claim 8 in which the biomarker is derived from the eigenvector having the smallest non-zero eigenvalue.

10. A method as claimed in claim 8 in which components of the biomaker are derived from n eigenvectors having the n smallest eigenvalues, and being larger than 0.

11. A method as claimed in claim 4 in which defining the biomarker includes transforming the pairwise measure into a plurality of components of the biomarker.

12. A method as claimed in claim 1 further including pre-selecting a set of structures for use in deriving the biomarker.

13. A method as claimed in claim 1 in which the images are brain images.

14. A method as claimed in claim 13 in which the condition of which the biomarker is indicative is Alzheimer's disease.

15. A method as claimed in claim 14 in which the one or more structures are left and right hippocampus, right lateral ventricle and left and right thalamus.

16. A method as claimed in claim 1 in which the biomarker is used as an input to a classifier to classify the query subject with respect to the condition.

17. A method as claimed in claim 16 in which the classifier is an unsupervised classifier.

18. A method as claimed in claim 16 in which the classifier is a supervised classifier.

19. A method as claimed in claim 16 in which the classifier is arranged to produce an output representing a classification score for the query subject.

20. A method of detecting disease progression including deriving a biomarker or classification score using a method as claimed in any one of the preceding claims at a first point in time; deriving a biomarker or classification score using a method as claimed in any one of the preceding claims at a second point in time; and detecting a change in the biomarker or classification score between the first and second points in time.

21. A method as claimed in claim 1 in which the condition is an illness, medical condition or a stage of the illness or medical condition.

22. A method of deriving a biomarker indicative of the progression of a disease using a method as claimed in any preceding claim, wherein the condition is a stage of the disease, the method including defining a set of respective digital medical images from the query subject and a plurality of groups of subjects at respective stages of the disease, the images being segmented into one or more labelled anatomical structures, defining a set of pairwise measures of similarity by comparing one or more respective anatomical structures for each pair of images in the set of images; and deriving the biomarker from the pairwise measures of similarity.

23. A computer program comprising coded instructions for implementing a method as claimed in any one of claims 1 to 22 when run on a computer.

24. A computer-readable medium or physical carrier signal encoding a computer program as claimed in claim 23.

25. A computer system arranged to implement a method as claimed in any one of claims 1 to 22.
